(19) United States
(12) Patent Application Publication
(10) Pub. No.: US 2003/0184196 A1
(43) Pub. Date: Oct. 2, 2003

(54) Hard disk cartridge not inclinable during removing

(76) Inventor: Kuo-Chuan Hung, Lu-Chou City (TW)

Correspondence Address: Chun Long Metal Co., Ltd., P.O. Box No. 6-57, Chung-Ho, Taipei, 235, TW

(21) Appl. No.: 10/302,920

(22) Filed: Nov. 25, 2002

(30) Foreign Application Priority Data
Mar. 27, 2002 (TW) 91203806

(51) Int. Cl. G11B 3/00

(52) U.S. Cl. 312/332.1; 312/333; 360/137

(57) ABSTRACT

A hard disk cartridge not inclinable during removing mainly has a frame; more particularly, a slidable pull rod disposed at the center on a face plate thereof has a row of teeth located at distal ends of two lateral sides thereof; two elongate swing blocks are disposed with one end of each of the swing block forms a circular convex portion disposed with teeth and the other end thereof forms a hook portion. The pull rod pushes forwards or rearwards to fitly drive the swing blocks on two lateral sides via the teeth thereby making the hook portion protrude or retract so as to achieve a clipping objective. The present invention has simplified parts, exerts even force and is not subjected to incline.

### BACKGROUND OF THE INVENTION

1) Field of the Invention

The present invention relates to a hard disk cartridge not inclinable during removing, more particularly, to a hard disk cartridge having a pull ring disposed at the center of a face plate thereof; pulling the pull ring releases a hook portion clipped on two lateral sides; reversely, pushing the pull ring inwardly resumes the two lateral sides steadily; the present invention is mainly featured that it operates smoothly without inclination.

2) Description of the Prior Art

Accordingly, most of the conventional hard disk cartridges use only one side thereof for clipping. Therefore, two lateral sides of said hard disk cartridge are often imbalanced during extraction thereby causing not smooth application and very possible damage to the hard disk cartridge and a computer case. “Improved Clipping Structure of a Hard Disk Drive” of Taiwan Patent NO, 467354, a design with slight improvement mainly has a press handlebar (70) disposed at a front end of the hard disk drive; a turning shaft (71) is disposed at one end of the press handlebar (70); a circular slot is disposed on the turning shaft (71) for placing in a spring (72); the periphery of the turning shaft (71) extends to form a protruding rim disposed with a clipping hook and a through hole; a link (80) connects the through hole and the other turning shaft (73) on the other side of a machine case (90); the turning shaft (73) is disposed with a clipping hook to make the press handlebar (70) close or open thereby driving the turning shaft (73) to rotate for making the clipping hook protrude or withdraw into the machine case (90) so as to retain or detach a retaining hole of a converting frame such that the hard disk cartridge enters or leaves the converting frame.

Wherein the machine case (90) has two inserting slots (91, 92) disposed respectively on two sides of a front end thereof for inserting two turning shafts (71, 73).

Although two sides of the abovementioned conventional structure clip synchronously, its implementation has the following shortcomings:

1. With too many parts, it increases the cost of the molding tool; its assembly is time-consuming and the abrasion loss rate thereof is high. That is its major shortcoming.

2. The press handlebar is of an inclined design. Grabbing the press handlebar to extract might possibly make the entire hard disk cartridge incline toward one lateral side thereby causing the abrasion loss of the parts and failing to radically solve the long existing problem of the conventional structure. Therefore the related products need improvement.

### SUMMARY OF THE INVENTION

The primary objective of the present invention is to design a hard disk cartridge not inclinable during removing with simplified structure so as to reduce the cost and be more practical. In order to achieve the objective, the present invention mainly has a frame; particularly, a pull hole is disposed on a face plate thereof; a bottom plate is sealed at a bottom portion at a front end of the face plate; a longitudinal guide rail and a transverse fixing block are respectively disposed in proper positions on the bottom plate; a shaft post is disposed adjacent to an outer lateral side; at least one resilient tab is disposed at a top portion of the fixing block; the resilient tab is in a shape of a suspending arm protruding at the front aspect; a bevel end and a concave arc are formed respectively from the outside to the inside; a pull ring is disposed at the center of a pull bar; two wing plates are disposed on two lateral sides; a row of teeth are disposed at one end portion of the wing plate; a longitudinal guide slot and a transverse convex tenon opposite each other and are respectively disposed on two lateral sides at a bottom portion of the wing plate. The pull bar is disposed at the upper aspect of a bottom plate behind the face plate. A pull ring pulls the pull bar outwardly from the pull hole. The guide slot fitly matches with the guide rail and pushes toward the direction accordingly. The convex tenon is disposed at the upper aspect of the resilient tab. One end of each two elongate swing blocks forms a circular convex portion with a shaft hole disposed at the center thereof; a peripheral portion on the outer lateral side thereof is disposed with teeth and the other end forms a hook portion; two shaft holes of two swing blocks insert into the shaft posts to mesh the outer annular teeth and the teeth on the wing plates; the hook portion protrudes the outer lateral side of the frame. When pull bar pushes to the inner most lateral side, the hook portion protrudes the two lateral sides to fixedly clip the machine case so as to fix the hard disk cartridge. Reversely, when the pull ring pulls toward the outer lateral side, the teeth on the wing plate drive the teeth on the swing block to rotate the hook portion thereby detaching the retaining so as to extract the hard disk cartridge.

To enable a further understanding the technical contents of the present invention, the brief description of the drawings is followed by the detailed description of a preferred embodiment.

### BRIEF DESCRIPTION OF THE DRAWINGS

FIG. 1 is an exploded drawing of the present invention.

FIG. 2 is a bird's-eye view drawing of the structure of the present invention.

FIG. 3 is the first lateral and cross-sectional drawing of the present invention.

FIG. 4 is a bird's-eye drawing of the movement of the present invention.

FIG. 5 is the second lateral and cross-sectional drawing of the present invention.

FIG. 6 is a rear view drawing of the present invention.

FIG. 7 is an external view drawing of a conventional structure.

FIG. 8 is an exploded drawing of the conventional structure.

### DETAILED DESCRIPTION OF THE PREFERRED EMBODIMENTS

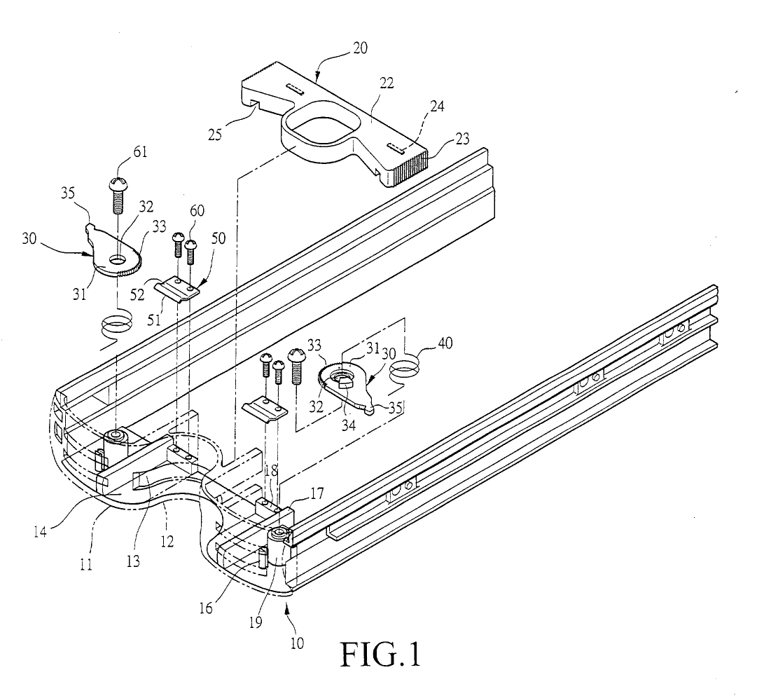

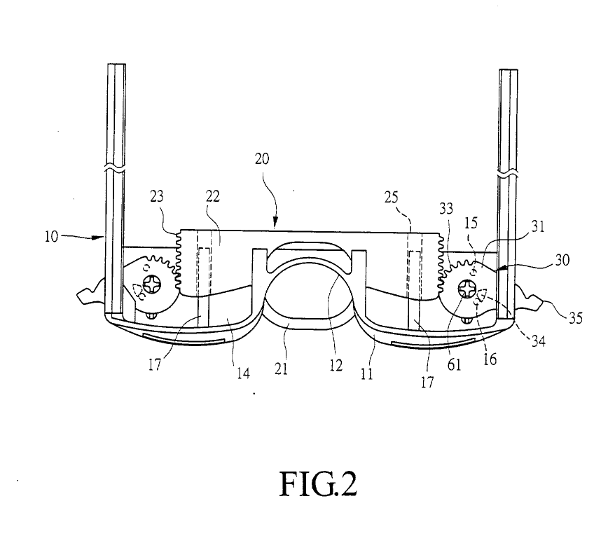

Referring to FIGS. 1 and 2, the present invention mainly comprises a frame (10) with a strip shape plate disposed respectively on two lateral sides thereof; particularly, a face plate (11) at least has a concave arc (12) disposed at the center thereof to form a wave shape. A pull hole (13) is transversely disposed on the concave arc (12); a bottom plate (14) is respectively sealed on a bottom portion between two lateral sides of the concave arc (12) on the face plate (11) and the frame (10). A longitudinal guide rail (17) and a transversely fixing block (18) are respectively disposed at proper positions on the bottom plate (14). A shaft post (19) is disposed adjacent to the outer lateral sides thereof; the rear and front sides of the shaft post (19) are respectively disposed with check bars (15, 16).

The fixing block (18) is disposed with a resilient tab (50) at the top portion thereof via a screw (60). The resilient tab (50) is in a shape of a suspending arm protruding at the front aspect; a bevel end (51) and a concave arc (52) are formed respectively from the outside to the inside of the fixing block (18).

A pull bar (20) is disposed with a pull ring (21) at the center thereof and two wing plates (22) are disposed on two lateral sides thereof. A row of teeth (23) is disposed respectively at end portions of the wing plate (22); a longitudinal guide slot (25) and a transverse convex tenon (24) opposite each other and are respectively disposed on two lateral sides of the bottom portion of the wing plate (22); the pull bar (20) is placed at the upper aspect of a bottom plate (14) behind the face plate (11) and extends outwardly from the pull hole (13) to the area of the concave arc (12) by a pull ring (21) but not protrudes too much; the guide slot (25) fitly matches with the guide rail (17) and pushes toward the direction accordingly. The convex tenon (24) is located at the upper aspect of the resilient tab (50).

One end of each of the two elongate swing blocks (30) forms a circular convex portion (31); wherein a shaft hole (32) is disposed at the center thereof; the peripheral portion on the outer lateral side is disposed with teeth (33); the other end forms a hook portion (35); a stop block (34) is disposed at a proper position. Two shaft holes (32) of the two swing blocks (30) insert onto the shaft posts (19) disposed with a torsional spring (40). A screw (61) threads in from the upper aspect of the shaft post (19) to fix and pivotally connect the swing block (30) as well as mesh the outer annular teeth (33) and the teeth (23) on the wing plate (22). The hook portion (35) protrudes the outer lateral side of the frame (10); a stop block (34) is located between two check bars (15, 16).

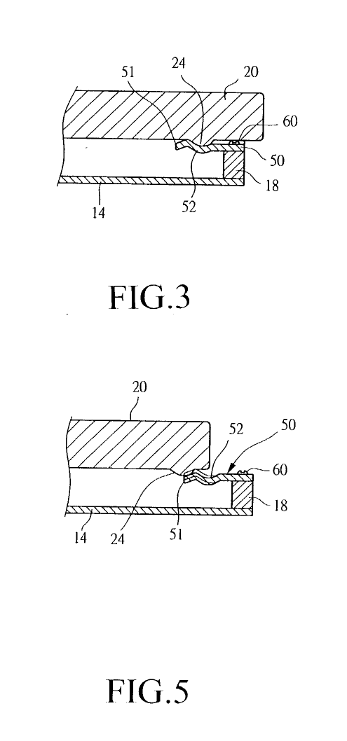

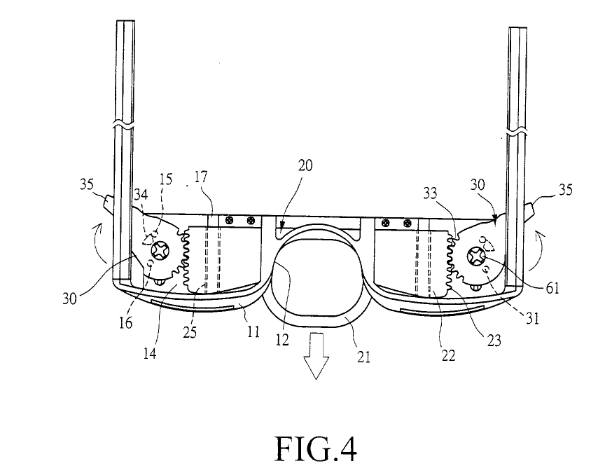

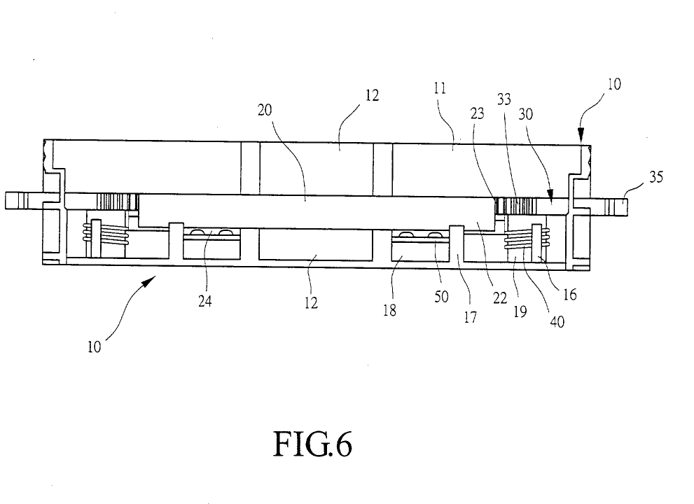

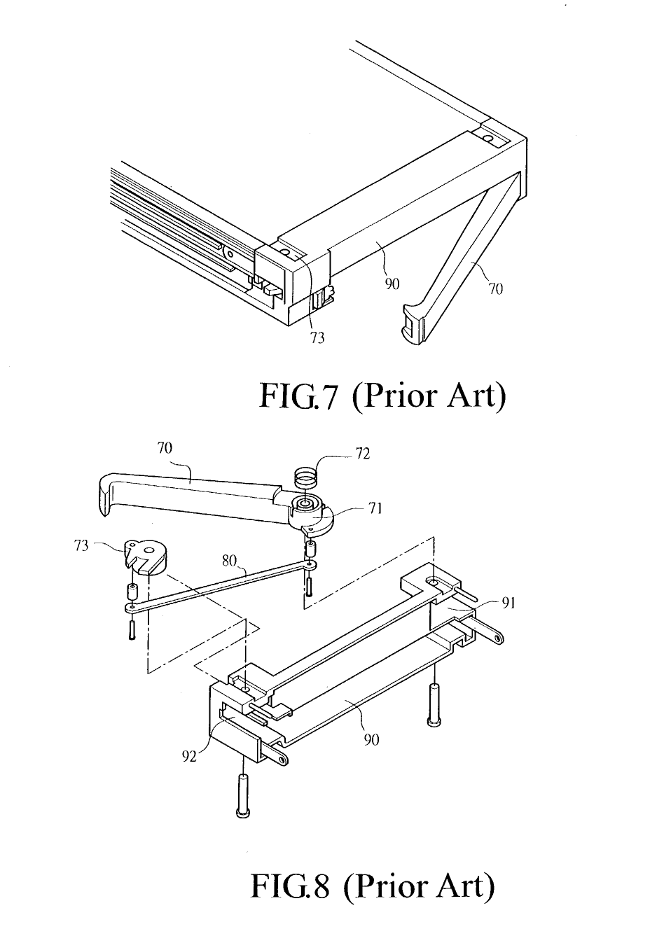

Referring FIGS. 2 and 3, when the pull bar (20) pushes to the inner most lateral side, the swing block (30) is pushed by the resilient force of the torsional spring (40) to press the stop block (34) against the check bar (16) area so as to make the hook portion (35) extend on two lateral sides to fixedly clip the machine case thereby fixing the hard disk cartridge. Reversely, as indicated in FIGS. 4 and 5, when the pull ring (21) pulls outwardly, the teeth (23) on the wing plate (22) drive the teeth (33) of the swing block (30) to rotate the hook portion (35) thereby detaching the retaining. At this time, the other check bar (15) fitly limits and positions the swing block (34) thereby allowing the extraction of the hard disk cartridge. When the pull ring (21) pushes toward the inner lateral side again, as indicated in FIG. 5, the convex tenon (24) first pushes the bevel end (51) of the resilient tab (50) to slightly make it move downwardly; during the continuous proceeding movement, the convex tenon (24) presses and resiliently retain inside a concave arc (52) for positioning. At this time, the teeth (23) on the outer lateral side of the wing portion (22) push the teeth (33) of the swing block (30) to make the hook portion (35) resume to the expanded position or protrude the clipped machine case, as indicated in FIG. 2.

The present invention has special design and the following advantages in application:

1. The pull bar of the present invention is disposed at the intermediate position; the pull ring is convenient for force exertion; exerting force at the center makes the two lateral sides release the pulling force at equal speed and with the same strength; therefore, it is more steady in extracting the hard disk cartridge with even strength thereby eliminating the inclining situation of the moment of force generated in a conventional structure. That is the primary advantage of the present invention.

2. The present invention used the pull bar to drive the hook portions on two lateral sides via the teeth such that not only the movement is more precise, but the speeds of the pull force to rotate and release two lateral sides are the same; it also reduces the abrasion loss and increases the useful life of the parts. That is one of the advantages of the present invention.

3. The number of the parts of the present invention is less than that of the conventional structure such that it saves the cost and the replacement rate of the parts; in addition, the driving effect is steady, specific and excellent. That is the advance of the present invention.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A hard disk cartridge not inclinable during removing mainly has a frame; particularly, a pull hole is disposed on a face plate thereof; a bottom plate is sealed on a bottom portion at a front end of the face plate; a longitudinal guide rail and a transverse fixing block are respectively disposed in proper positions on the bottom plate; a shaft post is disposed adjacent to an outer lateral side; at least one resilient tab is disposed at a top portion of the fixing block; the resilient tab is in a shape of a suspending arm protruding at the front aspect; a bevel end and a concave arc are formed respectively from the outside to the inside; a pull ring is disposed at the center of a pull bar; two wing plates are disposed on two lateral sides; a row of teeth is disposed respectively at one end portion of the wing plate; a longitudinal guide slot and a transverse convex tenon opposite each other and are respectively disposed on two lateral sides at a bottom portion of the wing plate; the pull bar is disposed at the upper aspect of a bottom plate behind the face plate; a pull ring pulls the pull bar outwardly from the pull hole; the guide slot fitly matches with the guide rail and pushes toward the direction accordingly; the convex tenon is disposed at the upper aspect of the resilient tab; one end of each two elongate swing blocks forms a circular convex portion with a shaft hole disposed at the center thereof; a peripheral portion on the outer lateral side thereof is disposed with teeth and the other end forms a hook portion; two shaft holes of two swing blocks insert into the shaft posts to mesh the outer annular teeth and the teeth on the wing plates; the hook portion protrudes the outer lateral side of the frame; when pull bar pushes to the inner most lateral side, the hook portion protrudes the two lateral sides to fixedly clip the machine case so as to fix the hard disk cartridge; reversely, when the pull ring pulls toward the outer lateral sides, the teeth on the wing plate drive the teeth on the swing block to rotate the hook portion thereby detaching the retaining so as to extract the hard disk cartridge.

2. A hard disk cartridge not inclinable during removing according to claim 1, wherein at least the center of the face plate is disposed with a concave arc to form a wave shape for fitly receiving the pull ring and preventing it from protruding too much outside the face plate.

3. A hard disk cartridge not inclinable during removing according to claim 1, wherein the front and rear lateral sides of the shaft post of the frame are respectively disposed with a check bar; a stop block is disposed at a proper position at the lower aspect of the swing block; the stop block is located between two check bars to prevent the swing block from detaching during rotation.

4. A hard disk cartridge not inclinable during removing according to claim 1, wherein a torsional spring is respectively disposed on the shaft posts at the lower aspect of the two swing blocks to make the hook portion of the swing block constantly have an expanding force to retain toward the two lateral sides.
